(19) United States
(12) Patent Application Publication
(10) Pub. No.: US 2017/0312687 A1
(43) Pub. Date: Nov. 2, 2017

(54) METHOD, SYSTEM, AND DEVICE FOR REMOVING HYDROGEN PEROXIDE OR HYDRAZINE FROM A PROCESS GAS STREAM

(71) Applicant: RASIRC, Inc., San Diego, CA (US)

(72) Inventors: Daniel Alvarez, JR., Oceanside, CA (US); Russell J. Holmes, San Diego, CA (US); Jeffrey J. Spiegelman, San Diego, CA (US); Edward Heinlein, San Diego, CA (US); Christopher Ramos, Bonita, CA (US)

(21) Appl. No.: 15/582,271

(22) Filed: Apr. 28, 2017

Related U.S. Application Data
(60) Provisional application No. 62/329,137, filed on Apr. 28, 2016.
(60) Provisional application No. 62/383,582, filed on Sep. 5, 2016.

(51) Int. Cl. B01D 53/86; B01J 35/00; B01J 23/889; B01J 23/72; B01J 23/46; B01J 21/04; B01J 35/02; B01J 38/12; B01J 23/755

(52) U.S. Cl. CPC B01D 53/8696; B01J 38/12; B01D 53/8621; B01J 35/0006; B01J 23/8892; B01J 23/755; B01J 23/72; B01J 23/468; B01J 21/04; B01J 35/026; B01D 53/8671; B01D 2255/20761; B01D 2255/20753; B01D 2255/2073; B01D 2255/65; B01D 2257/40

(57) ABSTRACT

Provided herein is a device for removing residual hydrogen peroxide or hydrazine from an effluent gas stream which includes a metal oxide scrubber material configured to react with residual process gases under increased temperatures. Also provided are systems and methods of using the same.

### CROSS REFERENCE TO RELATED APPLICATION(S)

This application claims the benefit of priority under 35 U.S.C. §119(e) of U.S. Ser. No. 62/329,137, filed Apr. 28, 2016, and of U.S. Ser. No. 62/383,582, filed Sep. 5, 2016. The entire content of each of these applications is incorporated herein by reference.

### TECHNICAL FIELD

The invention relates generally to decomposition of hydrogen peroxide and/or hydrazine and more specifically to methods, systems, and devices for removing residual hydrogen peroxide and/or hydrazine from an effluent gas stream.

### BACKGROUND

Various process gases may be used in the manufacturing and processing of micro-electronics. In addition, a variety of chemicals may be used in other environments demanding high purity gases, e.g., critical processes or applications, including without limitation microelectronics applications, wafer cleaning, wafer bonding, photoresist stripping, silicon oxidation, nitridation, surface passivation, photolithography mask cleaning, atomic layer deposition, chemical vapor deposition, flat panel displays, solar cells, disinfection of surfaces contaminated with bacteria, viruses and other biological agents, industrial parts cleaning, pharmaceutical manufacturing, production of nano-materials, power generation and control devices, fuel cells, power transmission devices, and other applications in which process control and purity are critical considerations. In those processes and applications, it is necessary to deliver specific amounts of certain process gases under controlled operating conditions, e.g., temperature, pressure, and flow rate.

For a variety of reasons, gas phase delivery of process chemicals is preferred to liquid phase delivery. For applications requiring low mass flow for process chemicals, liquid delivery of process chemicals is not accurate or clean enough. Gaseous delivery would be desired from a standpoint of ease of delivery, accuracy and purity. Gas flow devices are better attuned to precise control than liquid delivery devices. Additionally, micro-electronics applications and other critical processes typically have extensive gas handling systems that make gaseous delivery considerably easier than liquid delivery. One approach is to vaporize the process chemical component directly at or near the point of use. Vaporizing liquids provides a process that leaves heavy contaminants behind, thus purifying the process chemical.

One advantage of using gas in micro-electronics applications and other critical processes, as opposed to prior liquid-based approaches, is that gases are able to access high aspect ratio features on a surface. For example, in 2017, current semiconductor processes should be compatible with a half-pitch as small as 10 nm. The next technology node for semiconductors is expected to have a half-pitch of 7 nm, and with 5 nm half-pitch in the near future. At these dimensions, liquid-based chemical processing is not feasible, because the surface tension of the process liquid prevents it from accessing the bottom of deep holes or channels and the corners of high aspect ratio features.

As explained in PCT Publication Nos. WO2014014511 and WO2015175564 by Rasirc, Inc., which are hereby incorporated by reference herein, the gas phase use of hydrogen peroxide (H₂O₂) and hydrazine (H₄N₂) in critical process applications has been of limited utility because highly concentrated hydrogen peroxide and hydrazine solutions present serious safety and handling concerns, and obtaining high concentrations of hydrogen peroxide and hydrazine in the gas phase was not possible using previously available technology. Those publications describe the ability to reliably produce process gas streams containing concentrations of hydrogen peroxide and/or hydrazine in useful concentrations for critical processes or applications. For reasons of safety, environmental impact, and other chemical handling concerns, methods, systems, and devices for removing hydrogen peroxide and/or hydrazine from process gas streams are desired.

### SUMMARY OF VARIOUS EMBODIMENTS

Methods, systems, and devices for removing hydrogen peroxide and/or hydrazine from a process gas stream are provided. The methods, systems, and devices are particularly useful in removing residual process gases from an effluent gas stream resulting from micro-electronics applications and other critical processes and applications. Generally, the methods comprise contacting a process gas stream comprising hydrogen peroxide or hydrazine with a scrubber material at temperature and pressure conditions sufficient to substantially remove the hydrogen peroxide or hydrazine from the process gas stream.

Systems and devices for removing hydrogen peroxide or hydrazine from a process gas stream applying the methods described herein are also provided. Generally, the systems and devices comprise a scrubber material capable of removing hydrogen peroxide or hydrazine from a process gas stream and process control devices, e.g., heaters, pressure regulators, valves, and mass flow controllers, for controlling the conditions at which a process gas stream contacts the scrubber material.

Accordingly, in one aspect, the invention provides a device for removing process gas from an effluent gas stream, where the process gas is anhydrous hydrazine or hydrogen peroxide. The device includes a body having an outer surface, an inner surface forming a lumen, an inlet port in fluid communication with the lumen, and an outlet port in fluid communication with the lumen, an inlet diffuser disposed within the lumen in close proximity to the inlet port, an outlet screen disposed within the lumen in close proximity to the outlet port, scrubber material, such as manganese oxide, copper oxide, nickel oxide, iridium on aluminum oxide, or any combination thereof, disposed within the lumen between the inlet diffuser and the outlet screen, a heater disposed on the outer surface of the body, where the heater is configured to heat the body to about 80° C. to 500° C., and a controller in electrical communication with the heater. In various embodiments, the device also includes at least one thermocouple disposed within the lumen, on the outer surface of the body, within the inlet port, within the outlet port, or any combination thereof, wherein the at least one thermocouple is in electrical communication with the controller.

In various embodiments, at least one of the inlet diffuser and the outlet screen are removably attached to the inner surface of the body. In various embodiments, at least one of the inlet diffuser and the outlet screen are fixedly attached to the inner surface of the body, and wherein the body further comprises a fill port and an end cap. The heater may be any one or more of an electric band heaters, an electric jacket heater, an electric rope heater, a Peltier heat pump, a flame-based heater, a jacketed fluidized bed, and a plasma heater. In various embodiments, the inlet diffuser comprises a plurality of pores having a diameter of about 2.5 mm to about 0.1 mm. In various embodiments, the outlet screen comprises a plurality of pores having a diameter of about 1.5 mm to about 0.003 μm. In various embodiments, the scrubber material is at least 70% manganese oxide and/or at least 30% copper oxide.

In another aspect, the invention provides a method of decomposing/removing a process gas from an effluent process gas stream, where the process gas is anhydrous hydrazine or hydrogen peroxide. The method includes providing an effluent process gas stream comprising residual process gas in the device as disclosed herein, wherein the residual process gas is hydrogen peroxide or hydrazine, heating the device to about 80° C.-500° C., and controlling flow of the effluent process gas stream such that substantially all the residual process gas is removed from the effluent process gas stream. In various embodiments, at least about 90%, 95%, 98%, 99%, or 99.5% of the hydrogen peroxide or the hydrazine is removed from the effluent process gas stream. In various embodiments, greater than 99.5% of the hydrogen peroxide or the hydrazine is removed from the effluent process gas stream. The method may further include heating the effluent process gas stream to at least about 80° C. prior to providing the effluent process gas stream into the device. In various embodiments, the device is heated to about 100° C. to 150° C. In various embodiments, the scrubber material in the device is at least 70% manganese oxide. In various embodiments, the scrubber material is at least 30% copper oxide. In various embodiments, the method may further include regenerating the scrubber material after substantially all the residual process gas is removed from the effluent process gas stream. The step of regenerating may include exposing the scrubber material to a gas stream comprising oxygen at a temperature and pressure sufficient to regenerate active metal oxide sites in the scrubber material such that the regenerated scrubber material has at least 70% of its original activity, wherein activity is measured as the ability to remove hydrogen peroxide or the hydrazine from a process gas stream.

The methods, systems, and devices described herein are generally applicable to a wide variety of process gas streams containing hydrogen peroxide or hydrazine, particularly non-aqueous process gas streams wherein the gas stream is substantially free of water.

The systems and devices provided herein may further comprise various components for containing and controlling the flow of the gases and liquids used therein. For example, the systems and devices may further comprise mass flow controllers, valves, check valves, pressure gauges, regulators, rotameters, and pumps. The systems and devices provided herein may further comprise various heaters, thermocouples, and temperature controllers to control the temperature of various components of the devices and steps of the methods.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the embodiments and claims.

It is to be understood that both the foregoing general description and the following detailed description are exemplary and explanatory only and are not restrictive of the invention.

The accompanying drawings, which are incorporated in and constitute a part of this specification, illustrate several embodiments of the invention and, together with the description, serve to explain the principles of the invention.

### BRIEF DESCRIPTION OF THE DRAWINGS

FIG. 1 is cross-sectional view of an exemplary embodiment of the device of the present invention.

FIG. 2 a P&ID of a manifold that can be used to test methods, systems, and devices according to certain embodiments of the present invention.

FIG. 3 is a chart depicting the concentration of hydrogen peroxide in a process gas stream before and after the gas stream passed through a scrubber material according to certain methods, systems, and devices disclosed herein.

FIG. 4 is a chart comparing hydrogen peroxide decomposition efficiency against bed volume for various scrubber materials according to certain methods, systems, and devices disclosed herein.

FIGS. 5-14 are graphical diagrams depicting the temperature of the housing containing various scrubber materials during testing of the materials for hydrogen peroxide removal according to certain methods, systems, and devices disclosed herein. FIG. 5 shows the results from 46.7 g MnO₂ scrubber material. FIG. 6 shows the results from 23.4 g MnO₂ scrubber material. FIG. 7 shows the results from 11.5 g MnO₂ scrubber material. FIG. 8 shows the results from 11.5 g MnO₂ scrubber material. FIG. 9 shows the results from 69.0 g CuO. FIG. 10 shows the results from 69.0 g CuO. FIG. 11 shows the results from 35.0 g CuO. FIG. 12 shows the results from 17.5 g CuO. FIG. 13 shows the results from 39.27 g NiO. FIG. 14 shows the results from 20.3 g NiO.

FIG. 15 is a P&ID of a manifold that can be used to test methods, systems, and devices according to certain embodiments of the present invention.

FIG. 16 is a chart depicting the concentration of hydrazine in a process gas stream before the gas stream passed through a scrubber material according to certain methods, systems, and devices disclosed herein.

FIGS. 17A and 17B are a P&ID of a manifold that can be used to test methods, systems, and devices according to certain embodiments of the present invention.

### DETAILED DESCRIPTION

Various embodiments of the invention will now be explained in greater detail. It is to be understood that both the foregoing general description and the following detailed description are exemplary and explanatory only, and are not restrictive of the invention as claimed. Any discussion of certain embodiments or features serves to illustrate certain exemplary aspects of the invention. The invention is not limited to the embodiments specifically discussed herein.

Unless otherwise indicated, all numbers such as those expressing temperatures, weight percents, concentrations, time periods, dimensions, and values for certain parameters or physical properties used in the specification and claims are to be understood as being modified in all instances by the term “about.” It should also be understood that the precise numerical values and ranges used in the specification and claims form additional embodiments of the invention. All measurements are subject to uncertainty and experimental variability.

The term “critical process or application” as used herein is a broad term, and is to be given its ordinary and customary meaning to a person of ordinary skill in the art (and is not to be limited to a special or customized meaning), and refers without limitation to a process or application in which process control and purity are critical considerations. Examples of critical processes and applications include without limitation microelectronics applications, wafer cleaning, wafer bonding, photoresist stripping, silicon oxidation, nitridation, surface passivation, photolithography mask cleaning, atomic layer deposition, chemical vapor deposition, flat panel displays, solar cells, disinfection of surfaces contaminated with bacteria, viruses and other biological agents, industrial parts cleaning, pharmaceutical manufacturing, production of nano-materials, power generation and control devices, fuel cells, and power transmission devices.

The term “process gas” as used herein is a broad term, and is to be given its ordinary and customary meaning to a person of ordinary skill in the art (and is not to be limited to a special or customized meaning), and refers without limitation to a gas that is used in an application or process, e.g., a step in the manufacturing or processing of micro-electronics and in other critical processes. Exemplary process gases are reducing agents, oxidizing agents, inorganic acids, organic acids, inorganic bases, organic bases, and inorganic and organic solvents. A preferred process gas is hydrazine or hydrogen peroxide.

The term “carrier gas” as used herein is a broad term, and is to be given its ordinary and customary meaning to a person of ordinary skill in the art (and is not to be limited to a special or customized meaning), and refers without limitation to a gas that is used to carry another gas through a process train, which is typically a train of piping. Exemplary carrier gases are nitrogen, argon, hydrogen, oxygen, CO₂, clean dry air, helium, or other gases that are stable at room temperature and atmospheric pressure. In other cases, condensable gases like steam can be used as a “carrier gas”.

The term “non-aqueous solution” or “non-aqueous hydrazine solution” as used herein is a broad term, and is to be given its ordinary and customary meaning to a person of ordinary skill in the art (and is not to be limited to a special or customized meaning), and refers to a solution comprising hydrazine and optionally other components and containing less than 10% by weight of water. Exemplary non-aqueous solutions include those containing less than 2%, 0.5%, 0.1%, 0.01%, 0.001%, 0.0001% or less water, which solutions are referred to herein as “anhydrous hydrazine.”

As used herein, the term “effluent” refers to a liquid or gaseous waste stream exiting a system or device for producing or delivering a process gas that is used in an application or process, e.g., a step in the manufacturing or processing of micro-electronics and in other critical processes.

The methods, systems, and devices disclosed herein provide for decomposition of a residual process gas present in normal operation effluent after delivery of volatile process components to a critical process application to abate hazardous or otherwise undesired species in the effluent gas stream. It has been observed that in such systems and devices delivering the volatile process components, residual process gas remains in the effluent. For example, the effluent may contain about 5% or less residual process gas during normal operation. In many embodiments, the methods, systems, and devices disclosed herein are particularly applicable to hydrazine or hydrogen peroxide. However, certain devices disclosed herein are also applicable to other volatile process components. Thus, a goal was to design an on-board catalytic device (i.e., scrubber) that is sized to accommodate normal operational flow rates and process gas concentrations, while being configured for decomposing unknown mixed phase ratios in the effluent. For example, the methods and devices disclosed herein are configured to remove or decompose residual hydrogen peroxide or hydrazine in an effluent gas stream, where residual hydrogen peroxide or hydrazine has a concentration of about 5% or less (i.e., 5%, 4%, 3%, 2%, 1%, 0.5%, or less). Relative to effluent gas treatment systems of the prior art, the system of the present invention achieves various advantages in terms of clogging resistance and corrosion resistance, and flexibility in arrangement of effluent gas process units of the treatment system in a compact, efficient conformation.

The rapid decomposition of H₂O₂ in the presence of metallic impurities has been well documented. Many of the metallic catalysts available to promote rapid decomposition take advantage of the fact that the reaction is a disproportionation reaction (i.e., the hydrogen peroxide is both oxidized and reduced). Peroxides are unique in that oxygen exists in a −1 oxidation state (O⁻¹), which lies between the usual states of O⁰ and O⁻². Thus, the hydrogen peroxide can disproportionate to both O^{o} and O² according to the following:

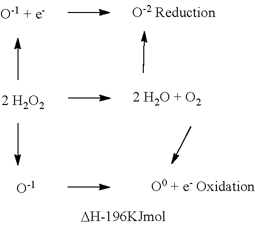

This coupled with the fact that transition metals such as Mn, Ni, Cu, Fe can exist in two different oxidation states allows the catalyst to break the reaction into two different redox steps, each of which has a lower energy barrier to completion than the uncatalyzed reaction. For example, using Fe:

H₂O₂ (aq)+2Fe³⁺ (aq)→O² (g)+2Fe²⁺+2H⁺ (aq)

H₂O₂ (aq)+2Fe²⁺ (aq)+2H⁺ (aq)→2H₂ (g)+2Fe³⁺ (aq)

Note the first step in the catalyzed reaction involves the reduction of Ferric Iron (Fe³⁺) to the Ferrous Iron (Fe²⁺), which is then re-oxidized to Ferric Iron in the second step. As such, the catalyst is not consumed during the course of the decomposition. The decomposition of hydrogen peroxide is considered a first order reaction, and therefore, the rate of reaction is expressed as: Rate=k{H₂O₂} with the value of k depending on temperature.

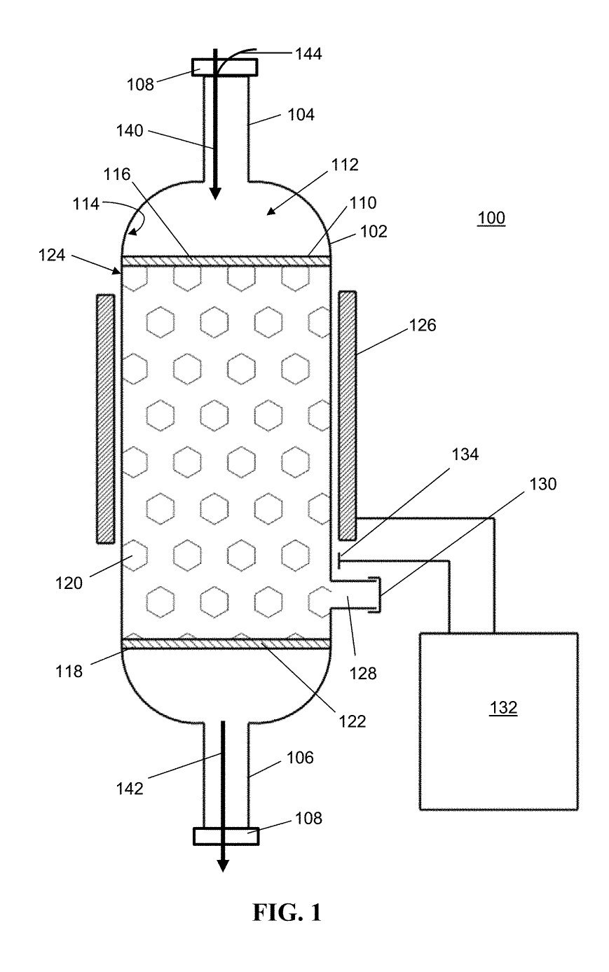

Accordingly, in one aspect, the invention provides a device 100 configures to decompose residual process gas in the effluent of a chemical delivery process. Referring now to FIG. 1, the device 100 includes a body 102 having an inlet port 104 and an outlet port 106 that are configured to flow effluent of a chemical delivery process or delivery system. As such, each of inlet port 104 and outlet port 106 may further include a coupler 108 configured to connect the device 100 to a chemical delivery process or system. The couplers 108 can take the form of a variety of connection configurations and sizes to permit fluid communication between the device 100 and the chemical process or system. Exemplary couplers include, but are not limited to, 1″ metal seals such as VCR® by Swagelok, 1″ MNPT, or other suitable connectors.

Disposed within a lumen of the body 102 is scrubber material/media/catalyst 120 configured to react/decompose residual process gas within the effluent gas stream 140 entering the inlet port 104 of the device 100. Exemplary scrubber materials 120 include, but are not limited to metal oxides, such as transitional metal oxides or oxides of a lanthanide series compound. In various embodiments, the scrubber material may be manganese oxide, copper oxide, nickel oxide, or any combination thereof. In various embodiments, the scrubber material 120 is a mixed metal oxide, such as a copper oxide-manganese oxide mixed metal oxide. In various embodiments the scrubber material includes at least 70% manganese oxide and/or at least 30% copper oxide. In various embodiments, the scrubber material is iridium on aluminum oxide, such as 5% iridium on aluminum oxide. Known materials useful as scrubber materials 120 include, but are not limited to CARULITE® 200 (a manganese dioxide/copper oxide catalyst available from Cams Corporation, Peru, Ill.), HIFUEL® R110 (a nickel oxide catalyst available from Alfa Aesar, Tewksbury, Mass.), and HIFUEL® W220 (a copper oxide catalyst available from Alfa Aesar, Tewksbury, Mass.).

Positioned in close proximity to the inlet port 104 is an inlet diffuser 110 that may be fixedly attached to the inner surface 112 of the body 102 or may be removably attached to the inner surface 112 of the body 102. Inlet diffuser 110 can take the form of a variety of shapes and sizes such that the flow rate of effluent gas 140 entering the device 100 is reduced and/or closely simulates iso-kinetic laminar flow through the device 100, thereby preventing recirculation zones, eddies, stagnation zones, and other anomalous flow behavior within the lumen 112 of body 102. In various embodiments, inlet diffuser 110 includes a plurality of coarse pores 116 that may range from about 0.1 mm to about 2.5 mm and may be formed from any material that can withstand high heat conditions and does not react with process chemicals within the effluent gas 140. In various embodiments, the inlet diffuser 110 is formed from a metal such as stainless steel.

Positioned in close proximity to the outlet port 106 is an outlet screen 118 that, like the inlet diffuser 110, may be fixedly attached to the inner surface 112 of the body 102 or may be removably attached to the inner surface 112 of the body 102. Outlet screen 118 can take the form of a variety of shapes and sizes such that the outlet screen 118 provides a constant resistance to the gas flowing through the lumen 112 of the body 102, and prevents scrubber material 120 and/or particles from exiting through outlet port 106 with the decomposed gas stream 142. In various embodiments, outlet screen 118 includes a plurality of fine (e.g., about 1.5 mm to about 0.003 μm) pores 122 and may be formed from any material that can withstand high heat conditions and does not react with process chemicals within the effluent gas. In various embodiments, the outlet screen 118 is formed from a metal such as stainless steel.

In various embodiments, the device 100 may further include one or more heaters 126 that may be provided in contact with and/or in close proximity to, the exterior surface 124 of the body 102. While the heater 126 may be provided in any size or configuration suitable for heating the device 100, exemplary heaters include, but are not limited to, electrical thermal treatment units (such as band heaters, jacket heaters, rope heaters, and Peltier heat pump), flame-based heaters, jacketed fluidized beds, plasma heaters. In various embodiments, heater 126 may be an insulating jacket configured to retain heat within the lumen 112 of the body 102 when a carrier gas of the effluent gas stream 140 is heated prior to entering the device 100.

As discussed above, inlet diffuser 110 and/or outlet screen 118 may be removably attached to the inner surface 114 of the body 102 to facilitate filling of the lumen 112 with the scrubber material 120 and/or replacement thereof. However, in embodiments where the inlet diffuser 110 and/or outlet screen 118 are fixedly attached to the inner surface 114 of the body 102, body 102 may include a fill port 128 configured to permit scrubber material 120 to be deposited into the lumen 112 and/or replaced. When so configured, fill port 128 may include an end cap 130 configured to seal fill port 128 during use of the device 100.

In various embodiments, device 100 may further include a controller 132 in electrical communication with the heater 126 and configured to provide electrical power to the heater 126 and/or regulate the heat being applied to the body 102. The device 100 may further include one or more thermocouples 134 provided in electrical communication with the controller 132 and configured to monitor the temperature of the body 102. In various embodiments, the thermocouple 134 may be disposed within the lumen 112 of the body 102 to monitor the temperature of the effluent gas 140 flowing within the lumen 112. When more than one thermocouple 134 is provided in the device 100, it is contemplated that each thermocouple 134 may be provided in positions to accomplish active monitoring of one or more of the temperature of the effluent gas 140 entering the inlet port 104, the temperature of the effluent gas flowing through the lumen 112, the temperature of the decomposed gas 142 exiting the outlet port 106, the temperature of the scrubber material 120, and the temperature of the body 102. Exemplary positions include, but are not limited to, within the lumen 112, on the outer surface 124 of the body 102, within the inlet port 104, within the outlet port 106, or any combination thereof.

In another aspect, the invention provides a method of decomposing a process gas in the effluent of a chemical delivery process. The method includes exposing the effluent stream 140 containing residual process gas to the scrubber material 120 within the lumen 112 of device 100 under conditions sufficient to remove/decompose substantially all the process gas therefrom. In various embodiments, the scrubber material 120 removes at least about 90%, 95%, 98%, 99%, 99.5%, 99.9%, 99.99%, 99.999%, 99.9999%, 99.99999% or 99.999999% of the residual process gas from the effluent gas stream. In various embodiments, the scrubber material 120 removes greater than 99.5% of the residual process gas from the effluent gas stream.

In various embodiments, the method may further include heating the scrubber material 120 and/or the device 100 containing the scrubber material 120 to at least about 80° C. to about 500° C., and preferably above 100° C., such as about 100° C. to about 150° C. Thus, in various embodiments, the scrubber material 120 and/or the device 100 may be heated to at least about 100° C., at least about 110° C., at least about 120° C., at least about 130° C., at least about 140° C., at least about 150° C., at least about 160° C., at least about 170° C., etc. In certain embodiments, the method may include heating the effluent gas 140 and/or a carrier gas 144 prior to entering the device 100. While any heating means may be used in conjunction with the effluent gas stream treatment system disclosed herein, exemplary heating means include, but are not limited to an electrical thermal treatment unit, a flame-based treatment, fluidized bed treatment, plasma treatment, internal heating via the carrier gas, as discussed above.

In various embodiments, the method may further include regenerating the scrubber material 120 after a predetermined time of use in decomposing the residual process gas in an effluent stream 140. Depending on the scrubber material used, regenerating the scrubber material 120 may include exposing the scrubber material 120 to an oxygen gas stream (or a gas stream comprising oxygen, such as, for example air) at a temperature and pressure sufficient to regenerate active metal oxide sites in the scrubber material. In various embodiments, the scrubber material 120 may be regenerated by exposing the scrubber material to the oxygen gas stream at a pressure of about 0 bar(g) to about 5 bar(g), and a temperature of about 200° C. to about 450° C. In various embodiments, the scrubber material to the oxygen gas stream at a pressure of about 0 bar(g) at a temperature of about 250° C. to about 300° C. In various embodiments, the scrubber material may be regenerated to at least 70% of its original activity, wherein activity is measured as the ability to remove hydrogen peroxide or hydrazine from a process gas stream.

Thus, in various embodiments, the scrubber material 120 be housed (i.e., packed) in a body 102, such as a stainless steel tube that is configured for fluidic communication with a system or device that delivers a process gas to a critical system. Once the effluent stream 140 is introduced into the device 100, the effluent stream 140 is permitted to contact the scrubber material 120 for sufficient time to allow for decomposition of the residual process gas contained therein. As discussed above, the device 100 is configured to alter the flow characteristics of the effluent gas stream 140 such that the flow closely simulates iso-kinetic laminar flow, to prevent recirculation zones, eddies, stagnation zones, and other anomalous flow behavior, which could cause incomplete decomposition during operation thereof. The decomposed gas stream 142 thereafter exits through the outlet port 106 and may optionally flow to a caustic scrubber to ensure complete detoxification thereof.

### Example 1

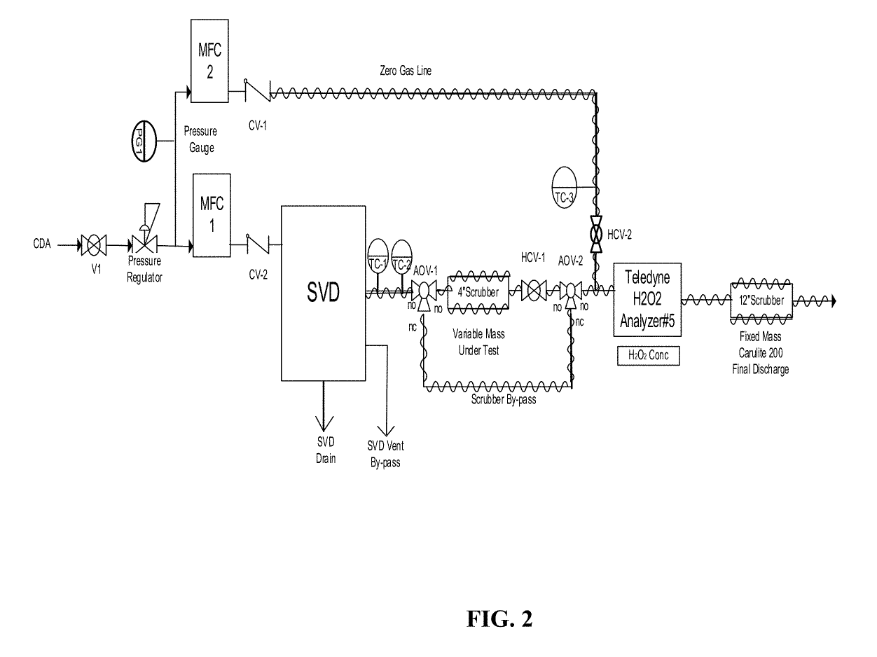

The manifold shown in FIG. 2 was used to test several scrubber materials according to the methods, systems, and devices disclosed herein. The manifold includes a stabilized vapor delivery (SVD) Peroxidizer device available from Rasirc, Inc. (San Diego, Calif.), providing a gas stream comprising hydrogen peroxide in a carrier gas. Three scrubber materials were tested as described below. The complete list of equipment used the test manifold and related tests is listed below:
Purified Clean Dry Air (CDA) Supply
30% Cleanroom Grade Hydrogen Peroxide
2—Pressure Regulators with Gauges
2—MFCs
1—MFC Control Box
2—Check Valves
Rasirc SVD Peroxidizer
2—PFA 3-Way Pneumatic Valves
1—PFA 2-Way Valve
1—Stainless steel (SS) 2-Way Valve
1—Ozone Analyzer with Mercury Lamp
2—Hydrogen Peroxide Scrubbers
Heat Tracing for Test Manifold (EZ Zone Watlow Controllers, Rasirc Universal Control Box, Temperature Controllers, Heater Tape, and Insulation)
Scrubber materials: either Carulite 200 4×8 Mesh Catalyst, MnO₂/CuO, ρ=0.85 g/ml; HiFuel R110, Steam Reformation Catalyst, NiO, ρ=0.90 g/ml; or HiFuel W220, Lo Temp, Water Gas Shift Catalyst, CuO, p=1.31 g/ml
3—3″×1″NPT SS Pipe Nipples
1—12″×1″NPT SS Pipe Nipple
6—1″NPT×⅜″ NPT SS Reducers
8—⅜NPT×⅜″ SS Tube Adapters
30 Mesh SS Screen
Hurricane 171cfm Inline Fan
2—Type J Thermocouples, Teflon coated
PLC Data Logger

During the tests, the carrier gas was clean dry air (CDA) maintained at 25 psig with a forward pressure regulator upstream of the mass flow controllers (MFCs) and 65 psig for the pneumatic valves. Two Brooks SLA5850S1EAB1B2A1 MFCs are used to set the carrier gas flow rates for the Zero Gas Line (10 slm) flowing to the analyzer and the SVD Peroxidizer (50 slm) providing a hydrogen peroxide containing gas stream to the scrubber bed. Check valves were placed between the MFCs and the Peroxidizer to prevent back flow of H₂O and H₂O₂ vapor. CDA gas runs through the Peroxidizer to add peroxide and water vapor to the gas stream. A 30% cleanroom grade hydrogen peroxide solution was used as the source solution for the Peroxidizer. The H₂O₂ containing gas stream from the Peroxidizer can flow through the test scrubber and then to the analyzer. Alternatively, the H₂O₂ containing gas stream from the Peroxidizer can bypass the test scrubber through 3-way PFA valves (AOVs 1 and 2), and flow directly to the analyzer. Additionally, a separate CDA zero gas flows to the analyzer through valve (HCVs1 and 2). The Peroxidizer's hydrogen peroxide fill vessel was weighed with a scale to determine the solution consumption rate.

A 1 inch inner diameter×4 inch long stainless steel test scrubber bed was used. The scrubber bed was loaded alternately with Carulite 200 4×8, HiFuel R110, or HiFuel W220 scrubber material. The test scrubber bed was placed upstream of the analyzer. A second 1 inch inner diameter×12 inch long stainless steel scrubber bed was placed downstream of the analyzer to ensure complete decomposition of the effluent vapor. The manifold tubing upstream of the analyzer is PFA. The heat-traced gas lines and components are controlled with an in-house temperature control box and Watlow controllers and kept at elevated temperature (typically between about 98° C. and about 120° C.) to prevent condensation. The entire manifold was setup inside of a fume hood. An inline fan was attached to the Peroxidizer's heat exhaust vent to keep the internal cabinet pressure at 0.13 inches H₂O.

The conditions for each test were 30 standard liters per minute (slm) flow of CDA with a pickup rate of H₂O₂ (about 25,000-30,000 ppm). Each scrubber material was subjected to a 1-2 hour test run in the test scrubber bed, monitoring break-through of H₂O₂ with the analyzer. Following each 1 to 2 hour run of the test scrubber, the analyzer was re-zeroed with CDA and allowed to stabilize for 20 to 30 minutes before proceeding to another test run. The mass of scrubber material in the bed was then reduced to 50% of the full load and tested at the above conditions. After a series of progressive 50% mass reduction tests with accompanying break-through measurements (percent ppm change), the minimum bed volume for 100% decomposition was extrapolated. Both scrubber beds were insulated and heated with heat tracing to between about 98° C. and about 120° C.

Ten runs were performed with the three scrubber materials in “as received” condition. The results of these tests are presented in Table 1. For the Carulite runs, Carulite 200, 70% MnO₂/30% CuO, (Carus Corp., Peru, Ill.) granule was packed tightly in the test scrubber bed. For the W220 runs, HiFuel W220 Copper Oxide, extruded cylindrical pellet, 0.140 inch×0.130 inch (Alfa Aesar, Ward Hill, Mass.) packed in the test scrubber bed. For the R110 runs, HiFuel R110 Nickel Oxide, hollow extruded pellet, 0.5 inch×0.4 inch (Alfa Aesar, Ward Hill, Mass.) packed loosely in the test scrubber bed.

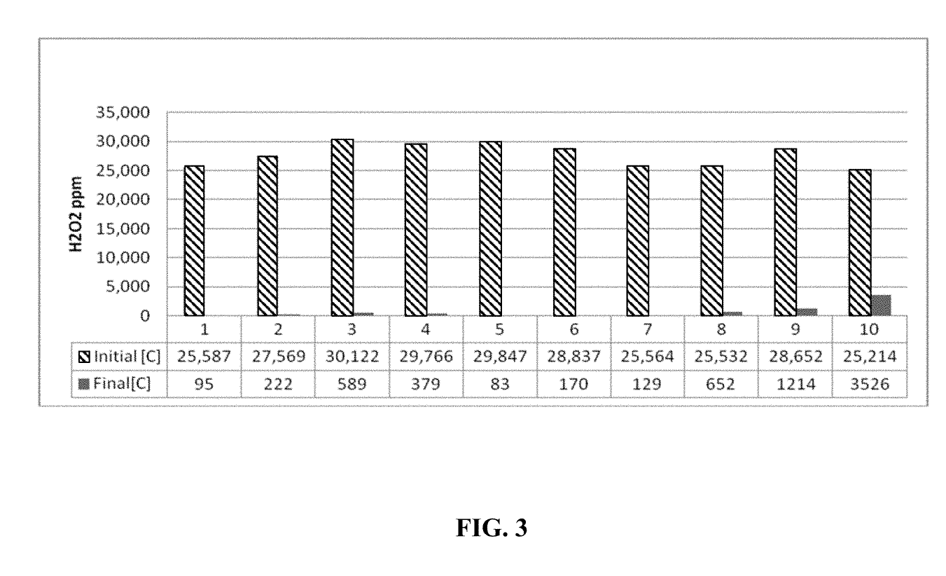

The data shows very low H₂O₂ break-through readings (less than 3% in most runs) for first 8 runs, see FIG. 3. In some cases, duplicate runs were required when the analyzer zero drift was suspect for inconsistent H₂O₂ final concentration readings. The results generally show a proportional relationship between the bed volume of a specific scrubber material and the extent of H₂O₂ decomposition efficiency. The tests with NiO (runs 9 and 10) were shortened to two runs as it was apparent the material was not performing as well as the other two compounds.

TABLE 1
Summary of H₂O₂ Catalytic Decomposition Test Runs

| | | | | Initial | Final | |
|---|---|---|---|---|---|---|
| | | | | H₂O₂ | H₂O₂ | % H₂O₂ |
| | Scrubber | Weight | Volume | Conc. | Conc. | Decom- |
| Run | Material | (g) | (ml) | (ppm) | (ppm) | position |
| 1 | Carulite | 46.7 | 54.94 | 25,587 | 95 | 99.63 |
| 2 | Carulite | 23.4 | 27.57 | 27,569 | 222 | 99.19 |
| 3 | Carulite | 11.5 | 13.53 | 30,122 | 589 | 98.04 |
| 4 | Carulite | 11.5 | 13.53 | 29,766 | 379 | 98.73 |
| 5 | W220 | 69 | 52.7 | 29,847 | 83 | 99.72 |
| 6 | W220 | 69 | 52.7 | 28,837 | 170 | 99.41 |
| 7 | W220 | 35 | 26.74 | 25,564 | 129 | 99.50 |
| 8 | W220 | 17.5 | 13.4 | 25,532 | 652 | 97.45 |
| 9 | R110 | 39.3 | 43.68 | 28,652 | 1214 | 95.76 |
| 10 | R110 | 20.3 | 22.55 | 25,214 | 3526 | 86.02 |

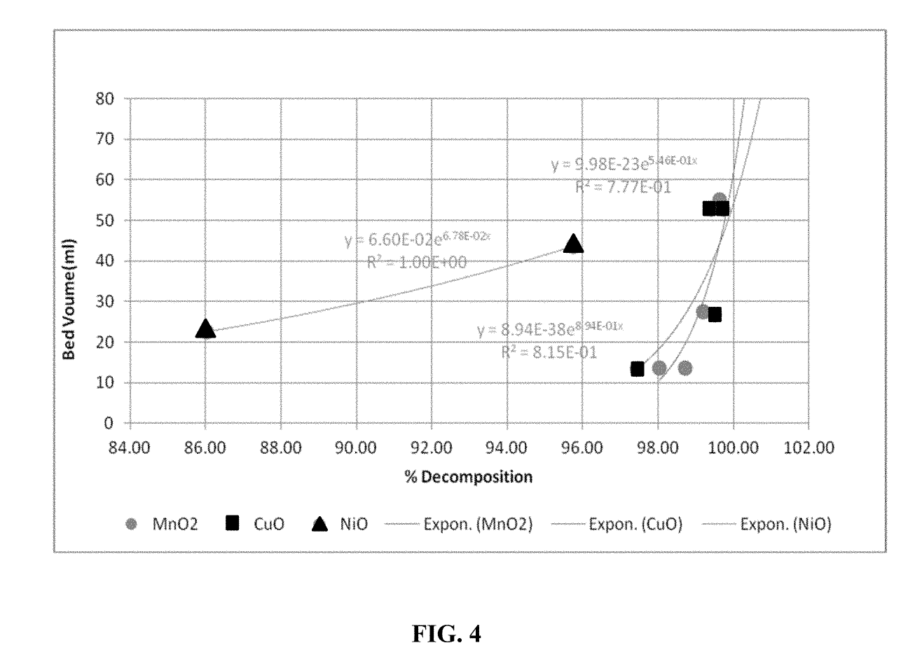

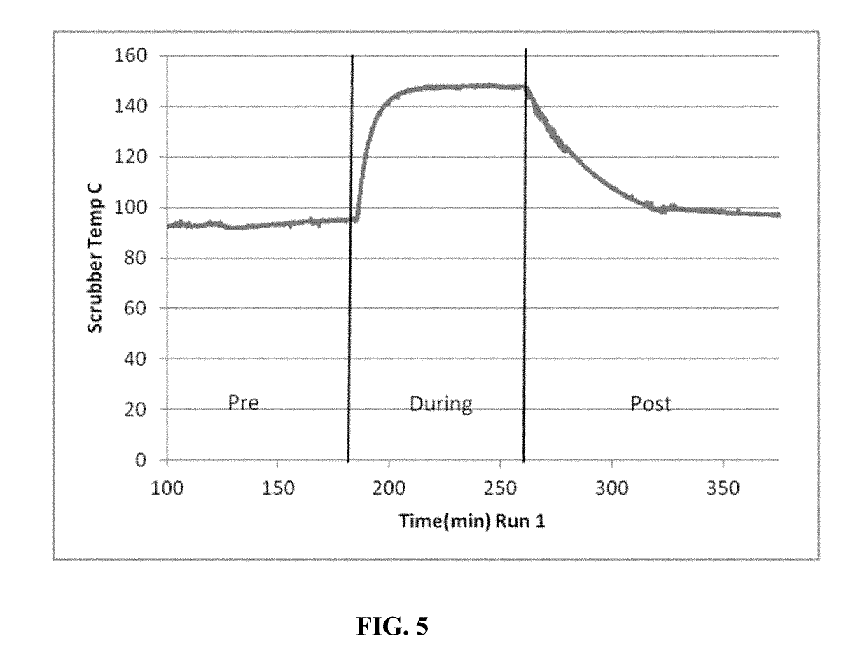

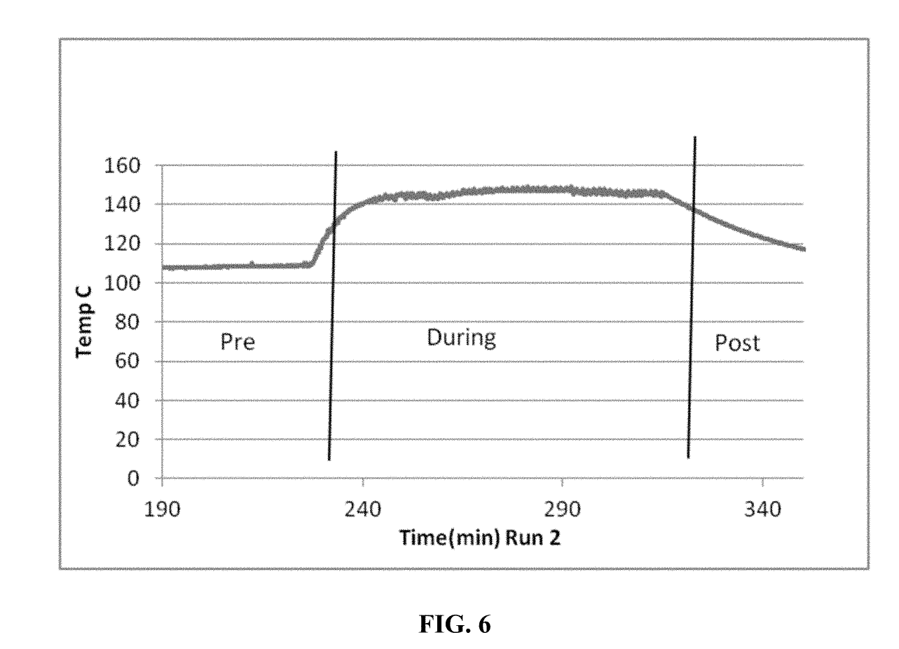

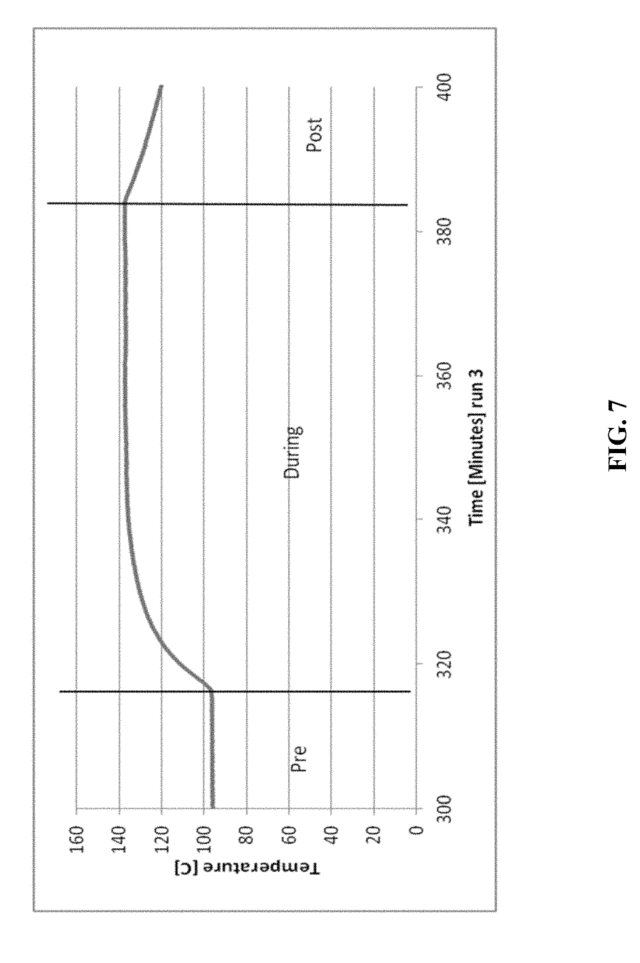

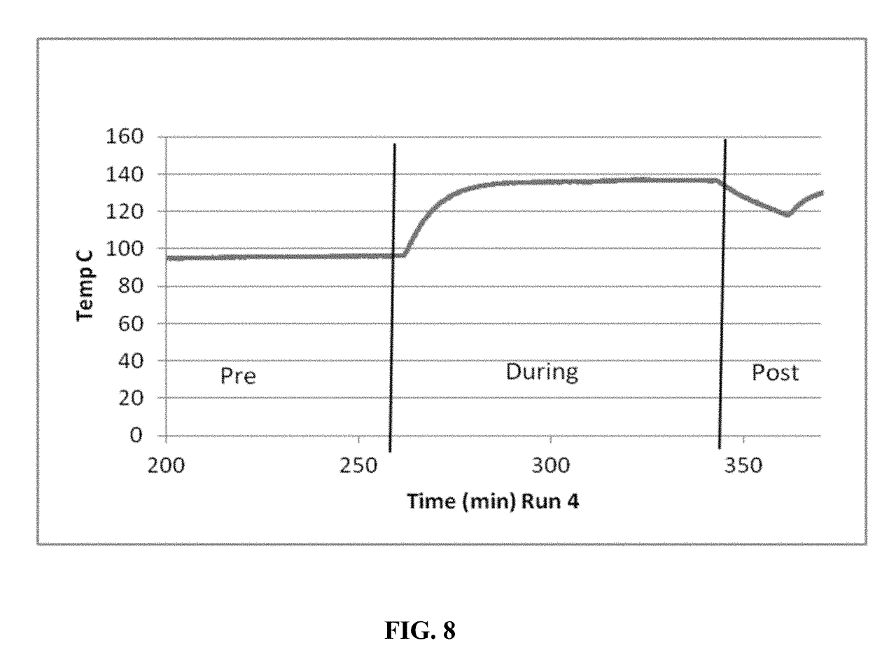

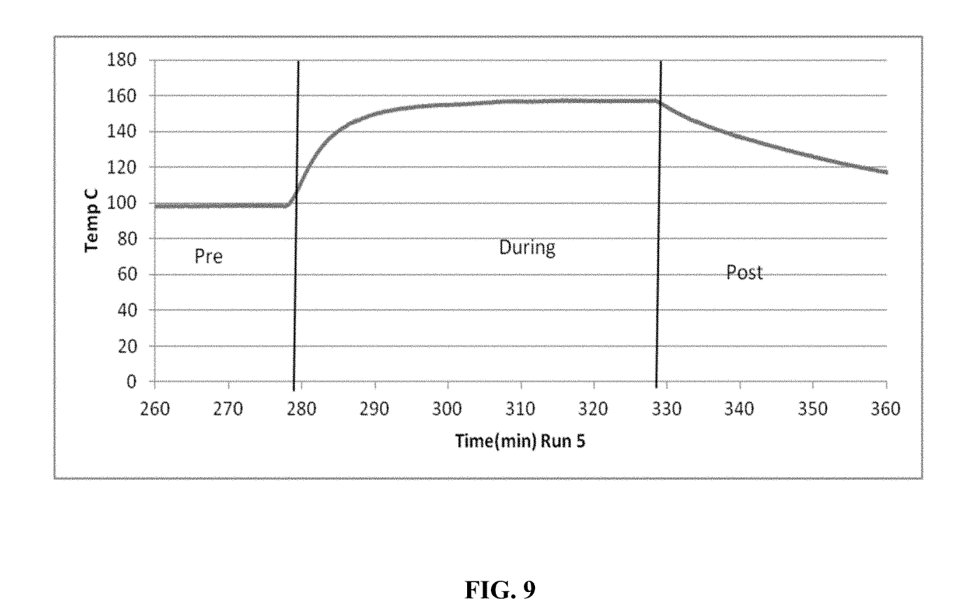

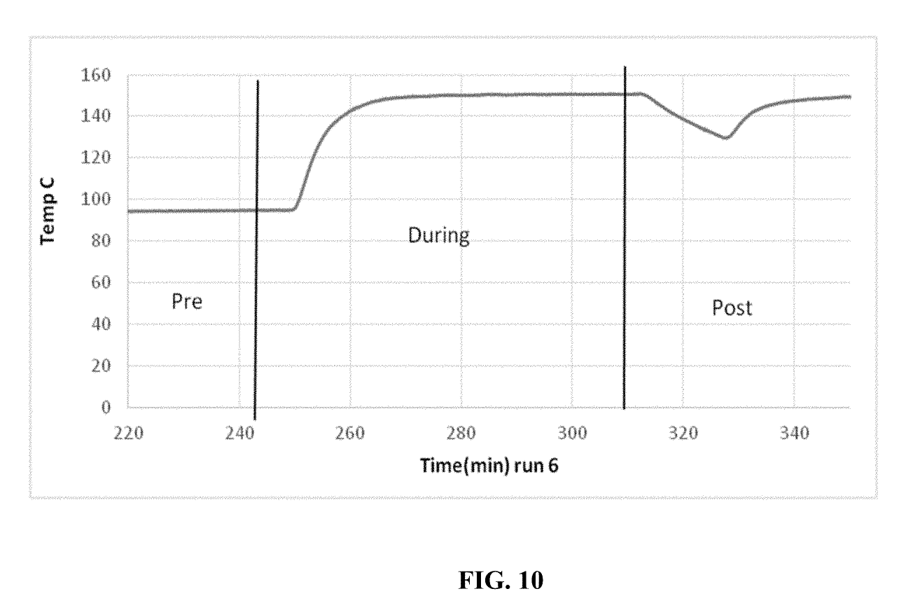

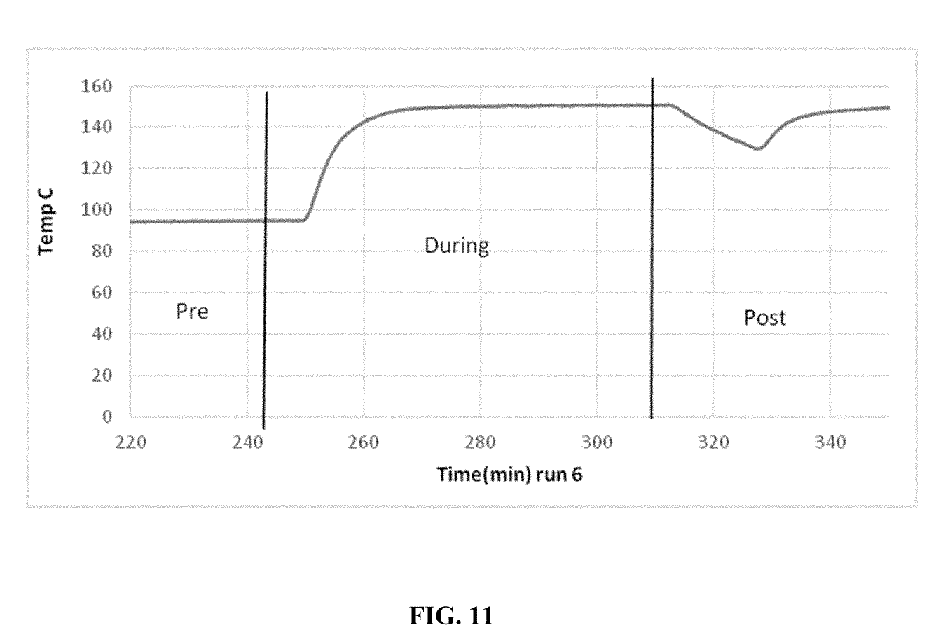

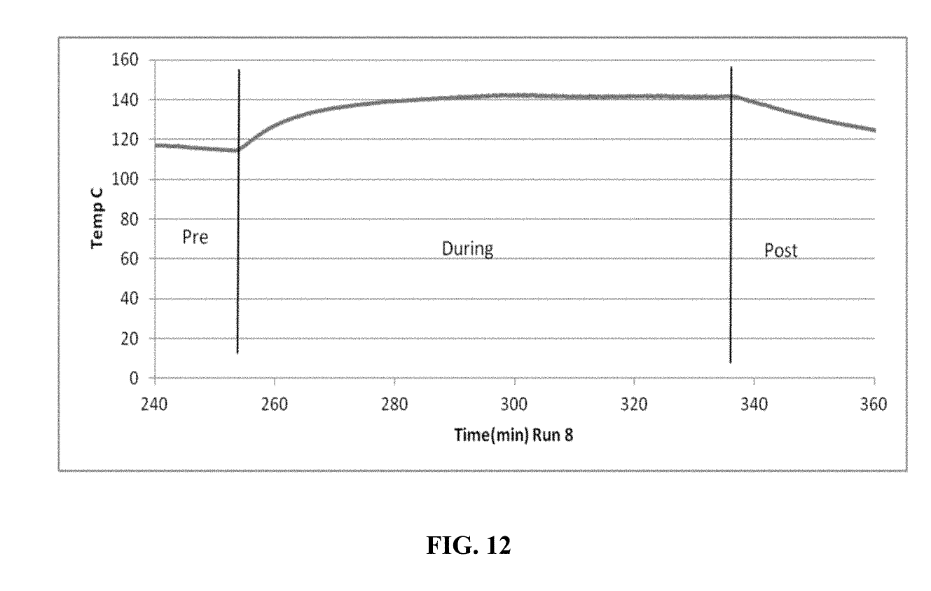

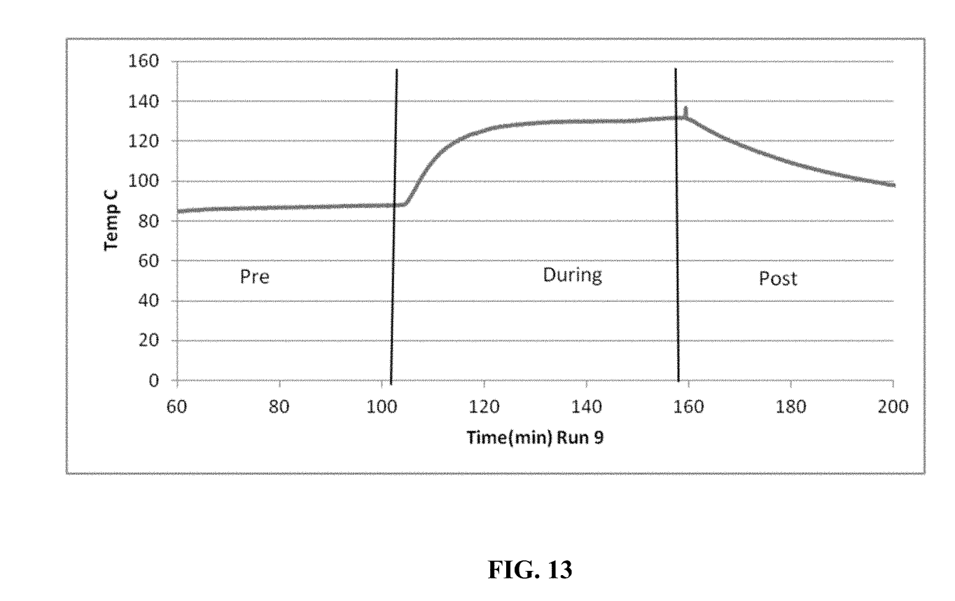

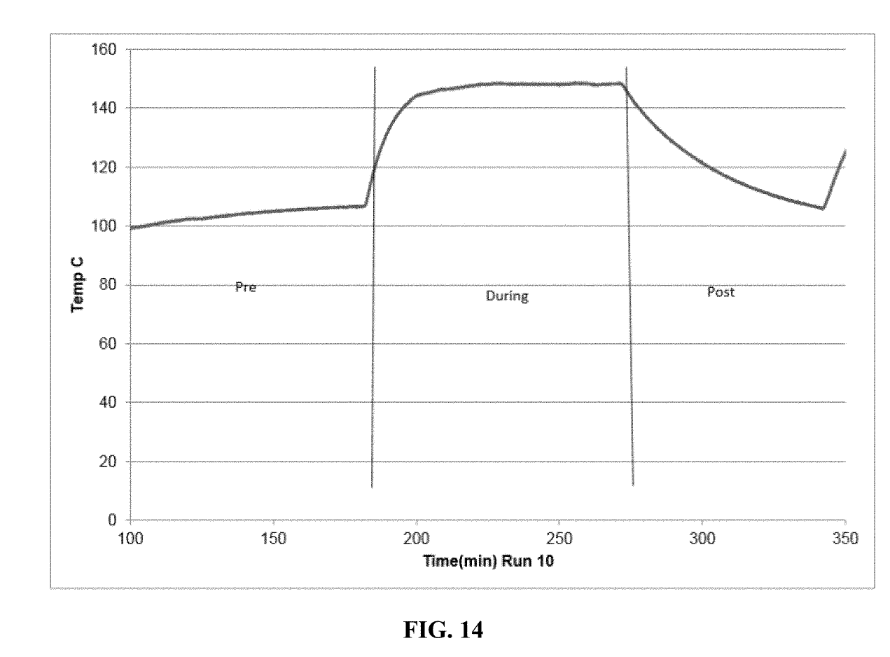

The values for predicted 100% H₂O₂ decomposition were calculated directly from the linear regression equations from FIG. 4 for each compound. Table 2 shows the extrapolated volume required for only the singular run condition of these experiments. However, the NiO bed volume extrapolated value needs further verification due to the aforesaid reasons.

TABLE 2
Scrubber Bed Volume Required to Achieve
100% Decomposition of H₂O₂

| Scrubber | Bed Volume for 100% |
|---|---|
| Material | Decomposition (mL) |
| Carulite | 59.88 |
| W220 | 51.48 |
| R110 | 57.20 |

### Example 2

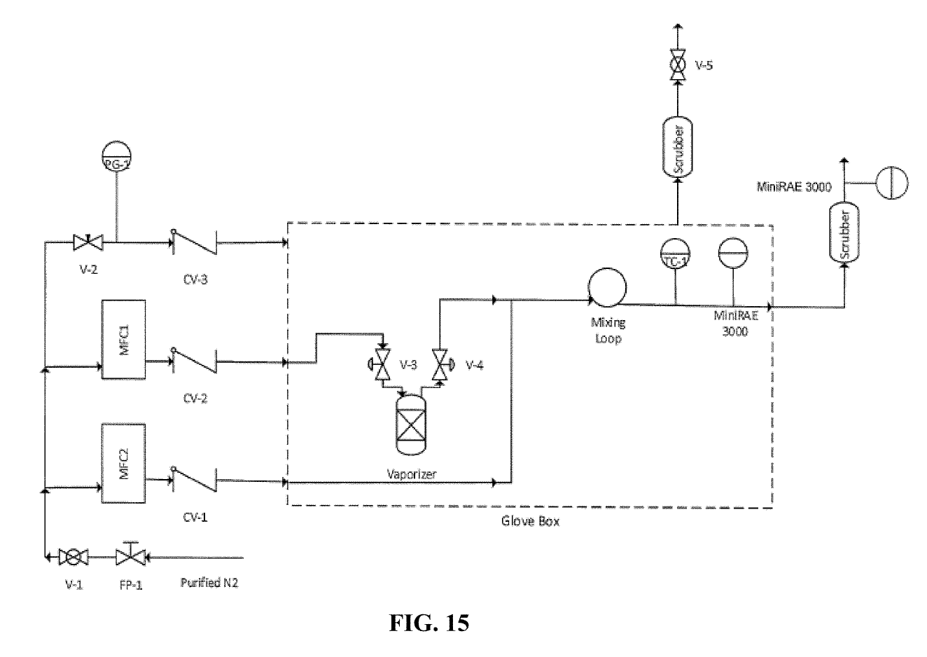

The manifold shown in FIG. 15 was used to test decomposition of hydrazine using scrubber materials according to the methods, systems, and devices disclosed herein. The manifold includes a Brute Hydrazine vaporizer available from Rasirc, Inc. (San Diego, Calif.), providing a gas stream comprising hydrazine in a carrier gas. The scrubber material was tested as described below. The complete list of equipment used with the test manifold and related tests is listed below:
Brute Hydrazine (65% Anhydrous hydrazine (>99.8%) in a Proprietary Solvent)
Glass syringe
Modified glove box (See FIG. 2)
Purified nitrogen source
2—Hydrazine scrubber containing Carulite 200 as described above
Forward pressure regulator (FP-1)
2—MiniRAE 3000 photoionization detectors (PID)
Stainless steel J-type thermocouple (TC-1)
30 PSIG pressure gauge
2—stainless steel ball valves (V-1, V-5)
Stainless steel needle valve (V-2)
Brute Hydrazine vaporizer 250 mL (Rasirc P/N 100701) equipped with 2¼-turn diaphragm valves (V-3 and V-4)
3—⅓ PSI check valves (CV-1, CV-2, and CV-3)

Purified nitrogen was supplied at 25 PSIG using a forward pressure regulator. A stainless steel ball valve (V-1) was used to isolate the setup if necessary. A stainless steel needle valve (V-2) was used to maintain and meter a positive pressure nitrogen purge inside the glove box. A 30 PSIG pressure gauge was used to monitor the pressure inside the glove box. A 5 SLM Brooks MFC (MFC1) was used to provide carrier gas to the vaporizer. A 10 SLM Brooks MFC (MFC2) was used to provide dilution gas. Three ⅓ PSI check valves (CV-1, CV-2, and CV-3) were used at each inlet to protect the MFCs and the environment from chemical exposure. A 250 mL Brute Hydrazine Vaporizer (Rasirc P/N 100701, Rasirc, San Diego, Calif.) was filled with a 65% w/w solution of hydrazine in a non-aqueous solvent and used to supply hydrazine. A mixing loop was used to ensure the gas was well mixed after dilution. A stainless steel J-type thermocouple (TC-1) was used to monitor the in-line gas temperature upstream of the analyzer. A MiniRAE 3000 photoionization detector (PID) was used to monitor the output of hydrazine during the test. The PID was calibrated using 100 PPM isobutylene gas prior to the experiment. A hydrazine scrubber comprised of Carulite 200 4×8 was used to decompose hydrazine from the process gas stream into N₂ and H₂. A second MiniRAE 3000 PID was used to measure hydrazine in the gas stream exiting the scrubber. A similar scrubber was used to decompose any hydrazine from the nitrogen purge. A stainless steel ball valve (V-5) was used to isolate the glove box if necessary. The hydrazine vaporizer, PID, and process tubing was setup inside the glove box. The entire setup was placed inside a fume hood.

The carrier gas was set to 500 sccm. The dilution gas was set to 6 SLM and may be decreased to dilute the concentration of hydrazine to approximately 1000 PPM (the upper detection limit of the analyzer being 2000 PPM) if necessary. Based on the ideal Raoult's law, the expected vapor pressure of hydrazine for the solution at 20° C. was calculated to be 9.27 Torr (about 12197 PPM at 760 Torr) requiring 6 SLM dilution gas for a concentration of approximately 1000 PPM. The scrubber material was sized to decompose 3 times the theoretical output using the ideal Raoult's Law calculation and a 6-hour process time. The outlet of the scrubber was periodically tested with a hydrazine PID analyzer to ensure no breakthrough of hydrazine occurred. The test setup and glove box were purged overnight prior to filling the vaporizer. Measurements from of the PID and TC-1 were recorded manually every 5-minutes for at least three hours.

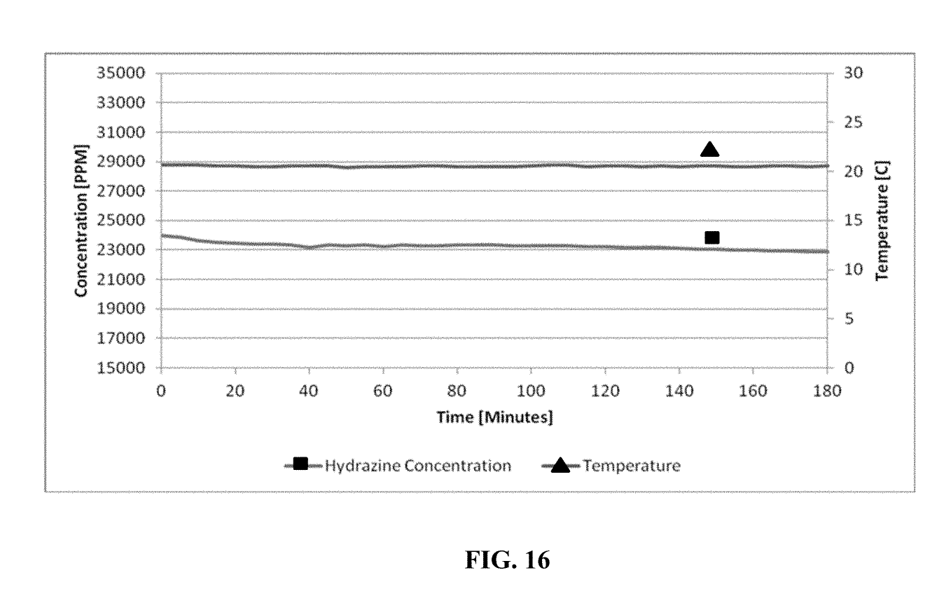

FIG. 16 shows the temperature and hydrazine concentration results for the Brute Hydrazine Vaporizer output. The initial hydrazine concentration read was 23,982 PPM, which settled after about 30 minutes to 23,373 PPM. The test continued for another 150 minutes with a final concentration of 22,890 PPM. The PID at the outlet of the scrubber was monitored every 5 minutes and registered 0.0 PPM throughout the test.

### Example 3

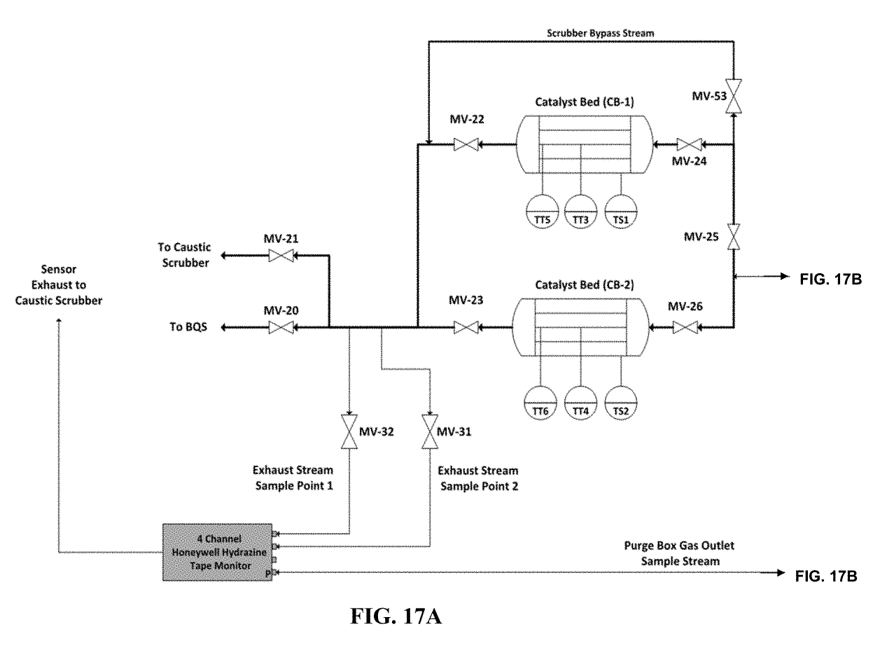

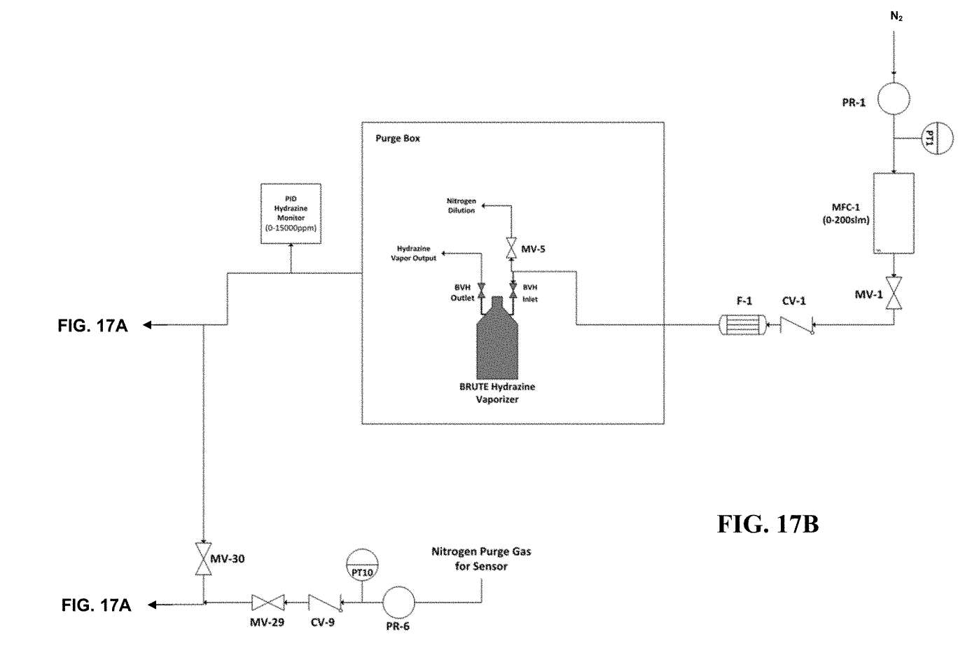

The manifold shown in FIGS. 17A and 17B was used to test decomposition of high flow, high concentration hydrazine vapor using scrubber materials according to the methods, systems, and devices disclosed herein. The manifold includes a Brute Hydrazine vaporizer available from Rasirc, Inc. (San Diego, Calif.), providing a gas stream comprising hydrazine in a carrier gas. The scrubber material was tested as described below. The complete list of equipment used to test the manifold and related tests is listed below:
Walking Fume Hood
   Draeger Polytron 7000 hydrazine safety monitor
Modified glove box (See FIGS. 17A and 17B)
   Stainless steel ball valves and diaphragm valves (MVs)
   Gas filter 0.003 um (F-1)
   Check valves (CVs), ⅓ PSIG
   Horiba STEC MFC (0-200 SLM)
   J Type Thermocouples (TTs)
   Pressure Transducers (PTs), 0-500 kPa
   Pressure regulator (PR-1), 0-60 PSIG
   175C Thermal Snap Switches (TSs)
   2 Heated hydrazine scrubbers (CB-1 and CB-2), one containing Carulite 200 as described above, and one containing 5% Iridium on Al₂O₃
Purified nitrogen source
MiniRAE 3000 photoionization detector (PID)
Brute Hydrazine Vaporizer (BHV) 250 mL (Rasirc P/N 100701)
Brute Hydrazine (65% Anhydrous hydrazine (>99.8%) in a Proprietary Solvent)
4 point Honeywell Hydrazine tape monitor (0-1000 ppb detection range)
Caustic Scrubber System

As shown in FIGS. 17A and 17B, purified nitrogen was supplied at 25 PSIG using a pressure regulator (PR-1) and monitored by pressure transducer (PT-1). A 200 SLM Horiba STEC MFC (MFC-1) was used to control carrier gas flow to the vaporizer. A stainless steel check valve (CV-1) was used to prevent backflow of hydrazine vapor into the MFC and upstream purified nitrogen supply. Gas filter (F-1) was placed upstream of the hydrazine vaporizer to prevent particle contamination from entering the process. A stainless steel valve (MV-1) was used to isolate carrier gas flow to the setup if necessary. A 250 mL Brute Hydrazine Vaporizer (Rasirc P/N 100701, Rasirc, San Diego, Calif.) was filled with a 65% w/w solution of hydrazine in a non-aqueous solvent and used to supply hydrazine vapor to the glove box atmosphere. Carrier gas flows through the vaporizer and picks up hydrazine vapor. The hydrazine vapor and carrier gas mix inside the 550 L glove box before exiting the purge box and entering the hydrazine scrubbing system. A MiniRae 3000 photoionzation detector (PID) monitored the hydrazine vapor concentration exiting the purge box and is used to measure the scrubber inlet concentrations. The PID was calibrated using 100 PPM isobutylene gas prior to the experiment and zeroed using purified nitrogen. A dual hydrazine scrubber system comprised of Carulite 200 4 X8 (CB-1) and 5% Iridium/Al₂O₃ (CB-2), each taking the form of a 3 inch outer diameter, 750 mL volume packed cylinder with 1″ VCR ports, as set forth in Table 4, was used to test decomposition of hydrazine from the process gas stream into N₂, NH₃ and H₂. Each hydrazine scrubber was independently heated using a 800 watt nozzle heater and an independent PID controller. Hydrazine vapor was sent to each hydrazine scrubber or a bypass stream by manipulating the following valves: MV-22, MV-23, MV-24, MV-25, MV-26, and MV-53 (described in more detail below). A 4-channel Honeywell Hydrazine Tape Monitor was used to measure hydrazine in the gas stream exiting the scrubbers. For redundancy, two downstream sample points were taken by opening MV-31 and MV-32. The Honeywell Hydrazine tape monitor is insensitive to ammonia and hydrogen gas. All process gases exiting the hydrazine scrubbers and sensors were routed to a caustic scrubber system which was used as an extra precaution to absorb any hydrazine that may break through and/or any ammonia that may have been formed during decomposition. The entire setup was placed inside a walk-in fume hood equipped with a Draeger Polytron 7000 hydrazine safety monitor.

TABLE 4
Scrubber Bed Volume Required to Achieve
100% Decomposition of High Flow N₂H₄

| | Catalyst/Scrubber | | |
|---|---|---|---|
| Pack Bed # | Material | Mass (g) | Packing Density |
| CB-1 (750 mL) | Carulite-200 | 504.1 g | 0.793 g/cm³ |
| CB-2 (750 mL) | 5% Iridium/Al₂O₃ | 360.6 g | 0.567 g/cm³ |

After installation of the two hydrazine scrubbers (CB-1 and CB-2), all lines were leak-checked with helium pressurized to 80 psig. A 65% w/w hydrazine in solvent solution was made in accordance with Example 2. The test commenced with all valves closed, and proceeded as follows.

Valves MV-23, MV-26, and MV-21 were opened first to flow nitrogen through CB-2 and to the caustic scrubber. Valves MV-1 and MV-5 were then opened to start the flow of nitrogen through the purge box and CB-2 at the desired test flowrate controlled by the MFC. The nozzle heater around each hydrazine scrubber was set to 150° C. and sufficient time was allowed for each bed to get up to temperature. Valves MV-31 and MV-32 were then opened to monitor the scrubber exhaust hydrazine concentration (range 0-1000 ppb). Valve MV-30 was opened to monitor the inlet concentration. The Mini Rae 3000 PID was re-zeroed under dry nitrogen flow. The BHV inlet and outlet valves were opened to start the flow of hydrazine vapor into the glove box atmosphere. To create and maintain certain part per million (PPM) hydrazine vapor challenges, the BHV inlet valve was opened and closed to adjust the purge box atmosphere hydrazine vapor concentration. The Mini Rae 3000 PID was used to measure the inlet hydrazine challenge concentrations sent to the hydrazine scrubbers (0-15000 ppm) and the two exhaust points of the Honeywell hydrazine tape monitor measured the break through concentrations (0-1000 ppb).

If scrubber inlet hydrazine concentration exceeded 1 ppm, MV-30 was closed and MV-29 was opened to purge the inlet sample point on the Honeywell tape monitor with nitrogen. PT-10 was set to 50 torr. To generate high inlet concentrations of hydrazine vapor, MV-5 was closed to flow directly through the BHV. All three Honeywell tape monitor ports, the Mini Rae 3000 PID, and the MFC flowrate were all monitored. Each concentration point and gas flowrate were maintained for 5 minutes if no breakthrough was seen or until the breakthrough concentration was found to be stable. To switch flow to CB-1, first MV-24 and MV-22 were opened. Then valve MV-25 was opened, and MV-26 and MV-23 were close to isolate CB-2. Reverse this process to return flow to CB-2. A summary of five minute breakthrough tests for a variety of flowrates and hydrazine vapor challenges are provided in Tables 5 and 6 for each scrubber material.

TABLE 5
CB-2, 5% Iridium-Alumina Hydrazine Vapor
Challenge and Breakthrough Data

| | | Exhaust | Exhaust | |
|---|---|---|---|---|
| | | Break- | Break- | |
| Gas | Hydrazine | through | through | Scrubber |
| Flow- | Vapor Inlet | Conc. | Conc. | Bed |
| rate | Challenge | Point 1 | Point 2 | Temperature |
| (SLM) | (PPM) | (ppb) | (ppb) | (° C.) |
| 15 | 0.3 | 0 | 0 | 150 |
| 15 | 27 | 0 | 0 | 150 |
| 35 | 21 | 0 | 0 | 150 |
| 45 | 21 | 0 | 0 | 150 |
| 15 | 530 | 0 | 0 | 147 |
| 15 | 3330 | 0 | 0 | 150 |
| 15 | 4600 | 0 | 0 | 150 |
| 15 | 5000 | 0 | 0 | 150 |
| 5 | >15000, Maximum | 0 | 0 | 150 |
| | Det. Limit | | | |
| 25 | 1080 | 0 | 0 | 150 |
| 30 | 930 | 0 | 0 | 150 |
| 40 | 840 | 0 | 0 | 150 |

TABLE 6
CB-1, Carulite-200 Hydrazine Vapor
Challenge and Breakthrough Data

| | | Exhaust | Exhaust | |
|---|---|---|---|---|
| | | Break- | Break- | |
| Gas | Hydrazine | through | through | Scrubber |
| Flow- | Vapor Inlet | Conc. | Conc. | Bed |
| rate | Challenge | Point 1 | Point 2 | Temperature |
| (SLM) | (PPM) | (ppb) | (ppb) | (° C.) |
| 15 | 283 | 0 | 0 | 154 |
| 15 | 2800 | 0 | 0 | 150 |
| 15 | 3300 | 0 | 0 | 150 |
| 15 | 4500 | 0 | 0 | 150 |
| 15 | 5000 | 0 | 0 | 150 |
| 5 | >15000, Maximum | 0 | 0 | 150 |
| | Det. Limit | | | |
| 25 | 900 | 0 | 0 | 150 |
| 30 | 933 | 0 | 0 | 150 |
| 40 | 720 | 0 | 0 | 150 |

The hydrazine vapor inlet challenges were kept within 5% of the stated value for each five minute test. No break-through was observed for any of the tests. To verify that the Honeywell tape monitor was functioning properly, the hydrazine scrubber bypass valve (MV-53) was cracked open for a fraction of a second at the end of the study with an inlet concentration of ˜100 ppm (MiniRae 3000 PID). Both hydrazine scrubber exhaust sample points 1 and 2 on the Honeywell tape monitor instantaneously reached the upper detection limit (>1000 ppb) and required 1 hour to purge before the valve returned to 0 ppb.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A device for removing anhydrous hydrazine gas from an effluent gas stream comprising:
(a) a body having an outer surface, an inner surface forming a lumen, an inlet port in fluid communication with the lumen, and an outlet port in fluid communication with the lumen;
(b) an inlet diffuser disposed within the lumen in close proximity to the inlet port;
(c) an outlet screen disposed within the lumen in close proximity to the outlet port;
(d) scrubber material disposed within the lumen between the inlet diffuser and the outlet screen, wherein the scrubber material is selected from the group consisting of manganese oxide, copper oxide, nickel oxide, iridium on aluminum oxide, or any combination thereof;
(e) a heater disposed on the outer surface of the body, wherein the heater is configured to heat the body to about 80° C. to 500° C.; and
(f) a controller in electrical communication with the heater.

2. The device of claim 1, wherein at least one of the inlet diffuser and the outlet screen are fixedly attached to the inner surface of the body, and wherein the body further comprises a fill port and an end cap.

3. The device of claim 1, wherein the scrubber material is at least 70% manganese oxide.

4. The device of claim 1, wherein the scrubber material is at least 30% copper oxide.

5. A device for decomposing hydrogen peroxide process gas from an effluent gas stream comprising:
(a) a body having an outer surface, an inner surface forming a lumen, an inlet port in fluid communication with the lumen, and an outlet port in fluid communication with the lumen;
(b) an inlet diffuser disposed within the lumen in close proximity to the inlet port;
(c) an outlet screen disposed within the lumen in close proximity to the outlet port;
(d) scrubber material disposed within the lumen between the inlet diffuser and the outlet screen, wherein the scrubber material is selected from the group consisting of manganese oxide, copper oxide, nickel oxide, iridium on aluminum oxide, or any combination thereof;
(e) a heater disposed on the outer surface of the body, wherein the heater is configured to heat the body to about 80° C. to 500° C.; and
(f) a controller in electrical communication with the heater.

6. The device of claim 5, wherein at least one of the inlet diffuser and the outlet screen are fixedly attached to the inner surface of the body, and wherein the body further comprises a fill port and an end cap.

7. The device of claim 5, wherein the scrubber material is at least 70% manganese oxide.

8. The device of claim 5, wherein the scrubber material is at least 30% copper oxide.

9. A method of decomposing anhydrous hydrazine gas within an effluent gas stream comprising:
(a) providing an effluent process gas stream comprising residual process gas in the device of claim 1, wherein the residual process gas is hydrazine;
(b) heating the device; and
(c) controlling flow of the effluent process gas stream such that substantially all the residual process gas is removed from the effluent process gas stream.

10. The method of claim 9, wherein the device is heated to about 80° C. to 500° C.

11. The method of claim 10, wherein the device is heated to about 100° C. to 150° C.

12. The method of claim 9, wherein the scrubber material in the device is at least 70% manganese oxide.

13. The method of claim 9, wherein the scrubber material in the device is at least 30% copper oxide.

14. The method of claim 9, wherein the residual process gas in the effluent process gas stream has a concentration of 5% or less.

15. The method of claim 14, wherein at least about 90%-99.5% of the hydrazine is removed from the effluent process gas stream.

16. The method of claim 14, wherein greater than 99.5% of the hydrazine is removed from the effluent process gas stream.

17. The method of claim 14, further comprising heating the effluent process gas stream to at least about 80° C. prior to the step of providing.

18. The method of claim 9, further comprising regenerating the scrubber material after substantially all the residual process gas is removed from the effluent process gas stream, wherein the step of regenerating comprises exposing the scrubber material to a gas stream comprising oxygen at a temperature and pressure sufficient to regenerate active metal oxide sites in the scrubber material.

19. The method claim 18, wherein the regenerated scrubber material has at least 70% of its original activity, wherein activity is measured as the ability to decompose hydrogen peroxide or hydrazine from a process gas stream.

20. A method of decomposing hydrogen peroxide gas within an effluent gas stream comprising:
(a) providing an effluent process gas stream comprising residual process gas in the device of claim 5, wherein the residual process gas is hydrogen peroxide;
(b) heating the device; and
(c) controlling flow of the effluent process gas stream such that substantially all the residual process gas is removed from the effluent process gas stream.

21. The method of claim 20, wherein the device is heated to about 80° C. to 500° C.

22. The method of claim 21, wherein the device is heated to about 100° C. to 150° C.

23. The method of claim 20, wherein the scrubber material in the device is at least 70% manganese oxide.

24. The method of claim 20, wherein the scrubber material in the device is at least 30% copper oxide.

25. The method of claim 19, wherein the residual process gas in the effluent process gas stream has a concentration of 5% or less.

26. The method of claim 25, wherein at least about 90%-99.5% of the hydrazine is removed from the effluent process gas stream.

27. The method of claim 25, wherein greater than 99.5% of the hydrazine is removed from the effluent process gas stream.

28. The method of claim 25, further comprising heating the effluent process gas stream to at least about 80° C. prior to the step of providing.

29. The method of claim 20, further comprising regenerating the scrubber material after substantially all the residual process gas is removed from the effluent process gas stream, wherein the step of regenerating comprises exposing the scrubber material to a gas stream comprising oxygen at a temperature and pressure sufficient to regenerate active metal oxide sites in the scrubber material.

30. The method claim 29, wherein the regenerated scrubber material has at least 70% of its original activity, wherein activity is measured as the ability to remove hydrogen peroxide or hydrazine from a process gas stream.
